(19) United States
(12) Patent Application Publication
(10) Pub. No.: US 2013/0197966 A1
(43) Pub. Date: Aug. 1, 2013

(54) ANALYTICS ENGINE, SYSTEM AND METHOD FOR ASSESSING AND PREDICTING RISK AND OPPORTUNITIES

(71) Applicant: IPQ Analytics LLC, Wynnewood, PA (US)

(72) Inventor: Michael Liebman, Kennett Square, PA (US)

(73) Assignee: IPQ Analytics LLC, Wynnewood, PA (US)

(21) Appl. No.: 13/707,410

(22) Filed: Dec. 6, 2012

Related U.S. Application Data
(60) Provisional application No. 61/567,480, filed on Dec. 6, 2011.

(51) Int. Cl. G06Q 10/06

(52) U.S. Cl. CPC G06Q 10/0635
USPC 705/7.28

(57) ABSTRACT

The present invention pertains to an analytics engine, system and method for providing risk/opportunity assessment and decision support solutions to users, such as for life sciences and healthcare constituents. The system includes an ontology based risk analytics engine that enhances its clients' decision making by systematically identifying and quantifying knowledge, which presents unexplored opportunities or risks. This independent review and evaluation leads to action plans that optimize critical project planning, improve success and outcome and lower costs. The system complements and extends existing internal decision processes and facilitates the systematic and unbiased application of knowledge to assist in making the best-informed decisions.

### CROSS REFERENCE TO RELATED APPLICATIONS

This application claims the benefit of priority to U.S. Provisional Patent Application No. 61/567,480, filed Dec. 6, 2011, the entire disclosure of which is incorporated by reference herein in its entirety.

### BACKGROUND OF THE INVENTION

It is well accepted that the barriers to entry are extremely high in the pharmaceutical industry. In overcoming these barriers, factors that influence the success of many pharmaceutical companies relate to capital requirements and financial resources, regulatory policies, and research and development, particularly at the clinical trial phase. These factors each influence one another and a lapse in one area can be disastrous for the future of a company. For example, in 2011 alone, pharmaceutical companies invested an estimated $100 billion in research and development. It takes about 10-15 years to develop one new medicine from the time it is discovered to when it is available for treating patients. The average cost to research and develop each successful drug is estimated to be $1.2 billion. This number includes the cost of the thousands of failures: For every 5,000-10,000 compounds that enter the research and development (R&D) pipeline, ultimately only one receives approval. And those that get approved don't necessarily succeed in the market. Currently, only 2 of every 10 marketed drugs return revenues that match or exceed R&D costs.

A clinical trial is a test or study of a drug, therapy, surgical procedure, medical device, or of nutrition or behavioral changes in people. Clinical trials are done to find out if the drug, therapy, procedure, etc. is safe and effective for people to use. Before a prospective treatment is tested on humans, it is thoroughly tested through laboratory and model studies to determine if it's safe. Physicians and other medical professionals run trials according to strict government based rules and regulations. For example, the U.S. Department of Health and Human Services has two offices that identify these rules: the Food and Drug Administration (FDA) and the Office for Human Research Protections (OHRP). These agencies have clinical practice requirements that establish rules every clinical trial must follow, such as how to conduct a study and how to protect human subjects. The federal government also has a policy that protects human subjects, called the “Common Rule,” that applies to all federally funded research. The Common Rule requires that an institutional review board must guarantee it will provide and enforce protection for people involved in its research. An institutional review board reviews and approves the trial protocol before the trial can even begin. It must look at the informed consent process, benefits and risks, and how volunteers will be selected. All such factors must be considered during the design and execution of a clinical trial.

Of the $1.2 billion that it costs to get a drug approved, clinical trials account for more than 50%. At present, only about 9% of drugs entering clinical trials succeed in being approved by the regulatory bodies, and many of those being approved don't succeed commercially upon introduction in the marketplace. It is estimated that at a 90% fail rate in clinical trials, every percentage point improvement in the success rate will save the industry hundred millions of dollars.

Undoubtedly, organizations need to mitigate risk for commercial performance, efficacy, safety and regulatory considerations. Additionally, the effective mitigation or reduction of risk as well as identification of new unexplored opportunities may also increase the likelihood of success, particularly at the clinical trial phase. Unfortunately, most risk/opportunity assessment is currently done solely at the operational level of clinical trials. Therefore, there is a need in the art for a system and method for systematically examining risk/opportunity at the hypothesis level (prior to commencing a trial), via a knowledge-based approach and converting it into prioritized actions. The present invention satisfies this need.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a diagram illustrating various concepts pertaining to a clinical trial, and the relationships between such concepts.

FIG. 2 is a chart depicting possible combinations of the concepts and relationships presented in FIG. 1.

FIG. 3 is a diagram of a knowledge representation in the healthcare domain, from the perspective concepts of drug, disease and target, and the relationships between them.

FIG. 4 is a diagram of natural language questions resulting from various combinations of concepts and concept relationships.

FIG. 5 is a chart of the generation of questions resulting from various combinations of concepts and concept relationships.

FIG. 6 is a screenshot of an exemplary user password authentication login page.

FIG. 7 is a screenshot of an exemplary home page.

FIG. 8 is a screenshot of an exemplary client document upload page.

FIG. 9 is a screenshot depicting an exemplary client document upload process.

FIG. 10 is a screenshot depicting an exemplary file selection for upload.

FIG. 11 is a screenshot of an exemplary client document download page.

FIG. 12 is a screenshot depicting an exemplary client document download process.

FIG. 13 is a screenshot of an exemplary user login page for accessing the client documents parsing platform.

FIG. 14 is a screenshot of an exemplary client documents parsing page.

FIG. 15 is a screenshot depicting an exemplary component of the client documents parsing process for disease concepts.

FIG. 16 is another screenshot depicting an exemplary component of the client documents parsing process for disease concepts.

FIG. 17 is another screenshot depicting an exemplary component of the client documents parsing process for disease concepts.

FIG. 18 is another screenshot depicting an exemplary component of the client documents parsing process for disease concepts.

FIG. 19 is a screenshot depicting an exemplary component of the client documents parsing process for drug and target concepts.

FIG. 20 is a screenshot of an exemplary survey results page.

FIG. 21 is a screenshot of an exemplary auditing function page.

FIG. 22 is a screenshot of an exemplary auditing function summary page.

FIG. 23 is a chart demonstrating the prioritization of natural language question sets.

FIG. 24 is a chart demonstrating the generation and evolution of new questions for inclusion in the selected question set.

FIG. 25 is a diagram of a database or knowledge repository network available for the system of the present invention. Mapping may occur at the index level.

FIG. 26 is a diagram of selected concepts and relationships.

FIG. 27 is a diagram demonstrating knowledge extension within the system of the present invention, where additional knowledge dimensions, based on the concepts and relationships of FIG. 26, can be generated.

FIG. 28 is diagram of a linkage between the system engine and the databases, based on the available knowledge within each of the dimensions of FIG. 27.

FIG. 29 is a diagram demonstrating how a user may prioritize the dimensionality of the problems using the extended knowledge, and based on commercial priorities or other considerations.

FIG. 30 is a diagram depicting the pulling and aggregation of relevant data from the available databases or repositories.

FIG. 31 is a flowchart of the overall process of the system of the present invention when used to assess risk and/or opportunities.

### DETAILED DESCRIPTION

It is to be understood that the figures and descriptions of the present invention have been simplified to illustrate elements that are relevant for a clear understanding of the present invention, while eliminating, for the purpose of clarity, many other elements found in analytic engines, systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods, materials or components similar or equivalent to those described herein can be used in the practice or testing of the present invention, the preferred methods, materials and components are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

“Hypothesis risk,” as used herein, refers to an incomplete consideration or evaluation of potential factors, before trial design, that could impact the trial's success, any inclusion or exclusion criteria, mapping of the trial population to real world patients, or the conversion from trial success to commercial success.

“Client knowledge” as used herein, refers to any component or information item of a client's knowledge base, and may include, without limitation, any paper or electronic document, file, image or other recordable medium. As contemplated herein client knowledge can also come in the form of client interview questionnaires and summaries that capture verbally expressed client knowledge.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present invention pertains to an analytics engine, system and method for providing risk/opportunity assessment and decision support solutions to users, such as for life sciences and healthcare constituents. However, while the description of the invention as provided herein pertains primarily to clinical trials, it should be appreciated that the system and methods of the present invention are not limited in their application. Rather, the present invention may be used in any field or with any application that requires decision support. For example, within pharma, the system may work with clinical groups to help evaluate the risks (and opportunities) in clinical trials before trial design; strategic analysis groups to help prioritize the pipeline and portfolio; BD&L evaluate in- and out-licensing opportunities as to potential risk; and drug repositioning activities to evaluate new opportunities and associated risks. The present invention uniquely evaluates the fundamental opportunities/risks that span the commercial, clinical and molecular domains, going far beyond operational considerations. Risk assessment at this early stage has also revealed new opportunities for drug indication, companion diagnostics, etc. and highlight issues that may arise when the commercial target is broader than the trial population.

By further example, within CRO's, the system helps differentiate their offerings to pharma and biotech organizations by enabling early stage consulting and risk evaluation and these partnerships, with CRO's, lead to channel marketing as well as direct business opportunities. With biotech investment groups, the system is involved in evaluating opportunities for product in- or out-licensing and also supporting the process of due diligence in licensing and investment considerations. With regulatory agencies, the system addresses their concern that “trial populations” do not resemble real world population and thus present post-approval risk, and have also positioned this with pharma companies to help them expand their opportunities for commercialization and enhanced market size. When expanded to healthcare systems and payer organizations, the system can evaluate opportunity/risk, both clinically and financially, associated with diagnostic and treatment practices and help to provide more effective and efficient care and outcomes to the benefit of their physicians and patients and at lower costs. These approaches can be applied both in clinical decision support at the patient level and to address issues of reimbursement and comparative effectiveness across the broader population-focused delivery of care. With the ongoing change in the healthcare system in the US and development of Accountable Care Organizations (ACO's), this becomes an increasingly critical issue that the present invention uniquely addresses.

In one embodiment, the system includes an ontology based risk analytics engine that predicts, identifies and/or assesses unexplored decision relevant risks/opportunities on a pre-occurrence basis. As contemplated herein, the system interprets client knowledge and related questions, extracts concepts, and identifies new dimensions of knowledge by examining the relationships between various knowledge domains. In this way, the system creates knowledge structures or representations previously unavailable to users, thereby allowing the user to more effectively assess and determine risk and opportunities.

The core component in identifying new knowledge opportunities is based on the system's ontology. Whereas most conventional ontologies attempt to represent knowledge residing within data repositories, the system's ontology is developed independently of specific datasets, and built from using generalizable concepts and relationships that represent the knowledge domain at a level that corresponds with how users interpret and define decision relevant information and associated risks/opportunities, and readily translates them into natural language questions, as described hereinthroughout. While the former is necessarily biased by the structure and format in which the data is stored, the latter, meaning the system ontology, is created with a view to represent the existing knowledge in a domain, such as the life sciences and healthcare domain. It should be appreciated that the system ontology can be applied into any knowledge domain. This approach, basing the ontology on the knowledge representation rather than representing the available data, allows a user to identify critical data elements that may not currently exist within available databases, public or private, and further suggest opportunities and applications for the development of such resources. With respect to potential applications in competitive analysis, the identification of potentially critical knowledge that may not exist can further lead to competitive advantage through the collection and/or generation of such critical data and application to the analysis of risk.

For example, in the pharmaceutical industry, the system of the present invention supports decision makers in assessing risks/opportunities in drug development, including validating a hypothesis from clinical studies that lead to improved trial designs and trial successes and commercial product success. In healthcare, the system can help clinicians in assessing and improving clinical practice, validating treatment options on a personalized basis, or help payer organizations in deciding about reimbursement for new diagnostics and treatments.

In life sciences, the system helps decision makers validate the basis and identify associated risks/opportunities of clinical trials by expanding a user's existing project knowledge (used for purposes of hypothesis generation and validation) into a more comprehensive and comprehensible representation and analysis of critical risk/opportunity factors to consider in the trial and ultimately product success. For example, in one exemplary embodiment of the present invention, the user may first access and answer selected questions from a library of natural language questions, and/or provide any applicable project specific knowledge in form of documentation, such as an investigator portfolio, etc. Next, the system interprets the selected questions and/or submitted documentation and identifies new dimensions of knowledge according to its ontology based algorithms and may optionally expand the scope of the selected questions to best reflect the breadth of available knowledge within accessible database sets, as well as identify when such data that may be critical does not exist within an accessible database. Next, the user reviews and prioritizes the system-generated questions according to their corporate/strategic objectives. In this phase, gaps and are identified and converted into natural language questions for convenient client communication and prioritization. These are then validated for their relevance in context of the project. The subsequent phase of opportunity/risk prioritization involves the identification and preliminary assessment of relevant data in terms of accessibility, i.e. what data sources may be available, how current is the data, is it validated? This is being accomplished by a generalized linking of the system ontology to commercial, public and client-owned data sets on the data field level. The system selectively pulls relevant data or other information items from the database sets, according to the relevant concepts and relationships identified by the system, and presents these results in a format suitable for the user to prioritize dimensions to evaluate risk and further applies novel algorithms to establish a quantifiable risk scoring. The system may optionally establish additional qualified inclusion/exclusion criteria, according to either or both of the user's input and the pulled data.

In one exemplary embodiment, the present invention can assess risk associated with a clinical trial before the trial is designed, thereby providing the user the opportunity to ultimately reduce risk or determine an acceptable level of risk. Historically, risk assessment at the clinical trial level is first made at the point of clinical trial design, where the research question about a population of interest is translated into a formal experiment and trial protocol. The trials are then performed as a single or multi-center set to test safety and efficacy issues. The system of the present invention significantly expands this assessment, by first assimilating observations from a variety of sources prior to clinical trial design, and frames a formal research question with a testable hypothesis via evaluation of a trial concept document. For example, the hypothesis can be expanded along the dimensions of clinical, molecular and commercial domains. After the trial is conducted, the system of the present invention further provides statistical analysis and interpretation of trial results in support of drug approval applications and product development for enhanced analysis and interpretation of the trial results.

In one aspect, the system can assess and optimize a clinical trial by taking into consideration failed trials, patent extension opportunities, and plan scope. The system identifies extended knowledge opportunities spanning the clinical, molecular and commercial domains using standard and/or custom questions in natural language to enhance the user's view with missing critical concepts and relationships that go beyond the initial scope of trial.

The system prioritizes available knowledge and pulls relevant data from one or more databases, or other disparate repositories. The system effectively enables the reduction of the dimensionality of extended knowledge based on commercial priorities and other considerations, and uses data extraction, transformation and loading (“ETL”) tools to direct data aggregation. Further, the system applies various modeling methods, including non-parametric statistical analyses, to quantify risks to provide actionable decision support for the user.

According to an aspect of the present invention, the system of the present invention may operate on a computer platform, such as a local or remote executable software platform, or as a hosted internet or network program or portal. In certain embodiments, only portions of the system may be computer operated, or in other embodiments, the entire system may be computer operated. As contemplated herein, any computing device as would be understood by those skilled in the art may be used with the system, including desktop or moble devices, laptops, desktops, tablets, smartphones or other wireless digitallcellular phones, televisions or other thin client devices.

For example, the computer operable component(s) of the system may reside entirely on a single computing device, or may reside on a central server and run on any number of end-user devices via communications network. The computing devices may include at least one processor, standard input and output devices, as well as all hardware and software typically found on computing devices for storing data and running programs, and for sending and receiving data over a network, if needed. If a central server is used, it may be one server or, more preferably, a combination of scalable servers, providing functionality as a network mainframe server, a web server, a mail server and central database server, all maintained and managed by an administrator or operator of the system. The computing device(s) may also be connected directly or via a network to remote databases, such as for additional storage backup, and to allow for the communication of files, email, software, and any other data format between two or more computing devices. The databases are also a location of available knowledge or information items, for pulling relevant data to be incorporated in the assessment of risk. There are no limitations to the number, type or connectivity of the databases utilized by the system of the present invention. The communications network can be a wide area network and may be any suitable networked system understood by those having ordinary skill in the art, such as, for example, an open, wide area network (e.g., the internet), an electronic network, an optical network, a wireless network, a physically secure network or virtual private network, and any combinations thereof. The communications network may also include any intermediate nodes, such as gateways, routers, bridges, Internet service provider networks, public-switched telephone networks, proxy servers, firewalls, and the like, such that the communications network may be suitable for the transmission of information items and other data throughout the system.

Further, the communications network may also use standard architecture and protocols as understood by those skilled in the art, such as, for example, a packet switched network for transporting information and packets in accordance with a standard transmission control protocol/Internet protocol (“TCP/IP”). Any of the computing devices may be communicatively connected into the communications network through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, the system may utilize any conventional operating platform or combination of platforms (Windows, Mac OS, Unix, Linux, Android, etc.) and may utilize any conventional networking and communications software as would be understood by those skilled in the art.

To protect data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the system may limit data manipulation, or information access. For example, a system administrator may allow for administration at one or more levels, such as at an individual user (patient) level, a healthcare professional level, or at a system level. A system administrator may also implement access or use restrictions for users at any level. Such restrictions may include, for example, the assignment of user names and passwords that allow the use of the present invention, or the selection of one or more data types that the subservient user is allowed to view or manipulate.

As mentioned previously, the system may operate as application software, which may be managed by a local or remote computing device. The software may include a software framework or architecture that optimizes ease of use of at least one existing software platform, and that may also extend the capabilities of at least one existing software platform. The application architecture may approximate the actual way users organize and manage electronic files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of the system to create components that plug into the architecture. Thus, software or portals in the architecture may be extensible and new software or portals may be created for the architecture by any party.

The system may provide software, for example, applications, such as for the assessment of risk, accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The system software may also provide a master GUI set that allows a user to select or interact with GUIs of one or more other applications, or that allows a user to simultaneously access a variety of information otherwise available through any portion of the system.

The system software may also be a portal or SaaS that provides, via the GUI, remote access to and from the system of the present invention. The software may include, for example, a network browser, as well as other standard applications. The software may also include the ability, either automatically based upon a user request in another application, or by a user request, to search, or otherwise retrieve particular data from one or more remote points, such as on the interne. The software may vary by user type, or may be available to only a certain user type, depending on the needs of the system. Users may have some portions, or all of the application software resident on a local computing device, or may simply have linking mechanisms, as understood by those skilled in the art, to link a computing device to the software running on a central server via the communications network, for example. As such, any device having, or having access to, the software may be capable of uploading, or downloading, any information item or data collection item, or informational files to be associated with such files.

Presentation of data through the software may be in any sort and number of selectable formats. For example, a multi-layer format may be used, wherein additional information is available by viewing successively lower layers of presented information. Such layers may be made available by the use of drop down menus, tabbed pseudo manila folder files, or other layering techniques understood by those skilled in the art or through a novel natural language interface as described hereinthroughout. Formats may also include AutoFill functionality, wherein data may be filled responsively to the entry of partial data in a particular field by the user. All formats may be in standard readable formats, such as XML. The software may further incorporate standard features typically found in applications, such as, for example, a front or “main” page to present a user with various selectable options for use or organization of information item collection fields.

The system software may also include standard reporting mechanisms, such as generating a printable results report, or an electronic results report that can be transmitted to any communicatively connected computing device, such as a generated email message or file attachment. Likewise, particular results of the aforementioned system can trigger an alert signal, such as the generation of an alert email, text or phone call, to alert a manager, Expert, researcher, clinician or other healthcare professional of the particular results.

The system takes an on-demand approach to data aggregation (pull vs. push) to provide “just-in-time” data access, such as by leveraging available content sets, including proprietary company data, or, case depending, identifying additional content. The system is “disease and platform agnostic” and therefore can be implemented with a number of different semantic search and content integration technologies, such as ii4sm, Temis, and NextBio, by non-limiting example.

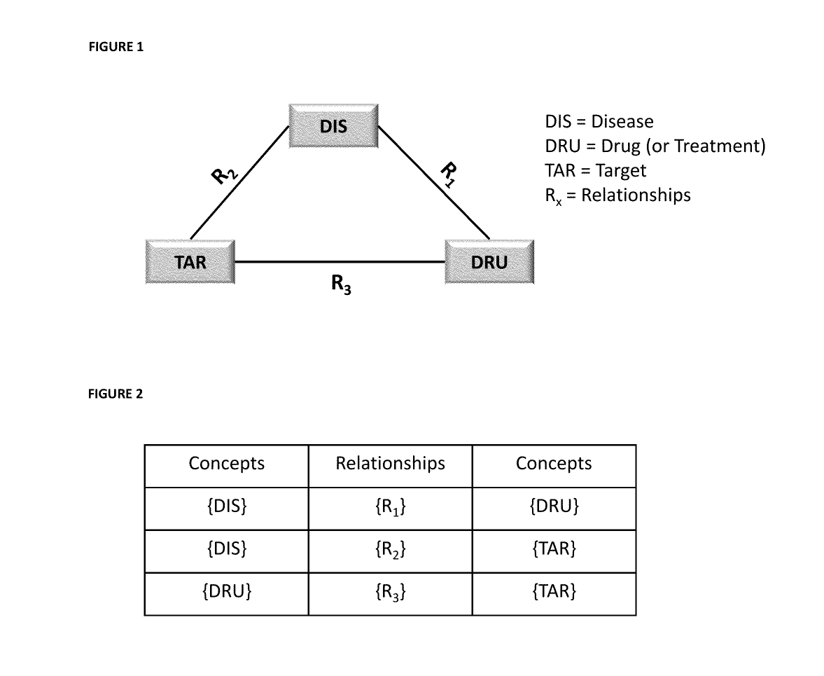

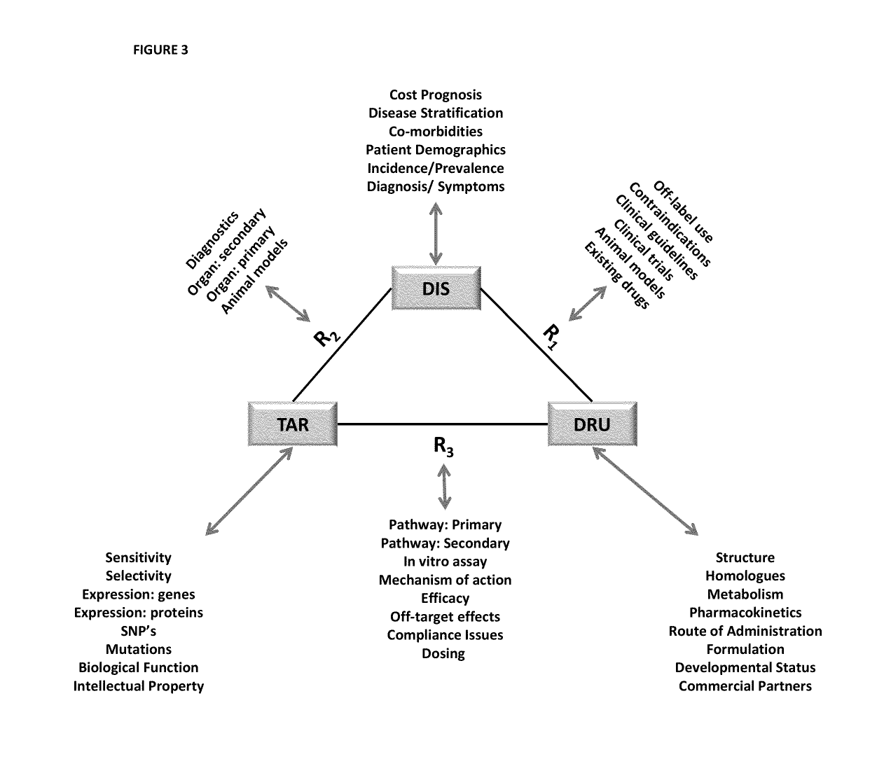

As contemplated herein, the system starts with the development of concepts and ontologies based on naturally disparate but functionally complementary perspectives in a knowledge domain. For example, as depicted in FIG. 1, three such perspectives in the healthcare and life sciences industries can be, without limitation, the disease, the drug target and the drug molecule. In other embodiments, and depending on the application, the drug molecule perspective may alternatively be a medical device perspective, instrumentation perspective, a treatment or treatment regime perspective, or a diagnostic perspective. The system ontology evolves around concepts, which are associated with each of the three exemplary healthcare perspectives and the relationships, which link them, as depicted in FIG. 2. This knowledge representation describes the life sciences and healthcare domain from a drug (or alternatively a device or treatment), disease and target perspective. For example, as depicted in FIG. 3, the system ontology may include information relating to diseases can pertain to, without limitation, cost prognosis, disease stratification, co-morbidities, patient demographics, disease incidence/prevalence, and disease diagnosis/symptoms. Information relating to drugs can pertain to, without limitation, structure, homologues, metabolism, pharmacokinetics, route of administration, formulation, developmental status, commercial partners and intellectual property. Information relating to targets can pertain to, without limitation, sensitivity and selectivity, gene and/or protein expression, SNP's, mutations, biological function and intellectual property. Furthermore, relationships between drug and disease can pertain to, without limitation, off-label use, contraindications, clinical guidelines, clinical trials, animal models and existing drugs. Relationships between targets and disease can pertain to, without limitation, diagnostics, primary and secondary organs, and animal models. Lastly, relationships between drugs and their targets can pertain to, without limitation, primary and secondary pathways, in vitro assays, mechanism of action, efficacy, off-target effects, dosing, and compliance issues.

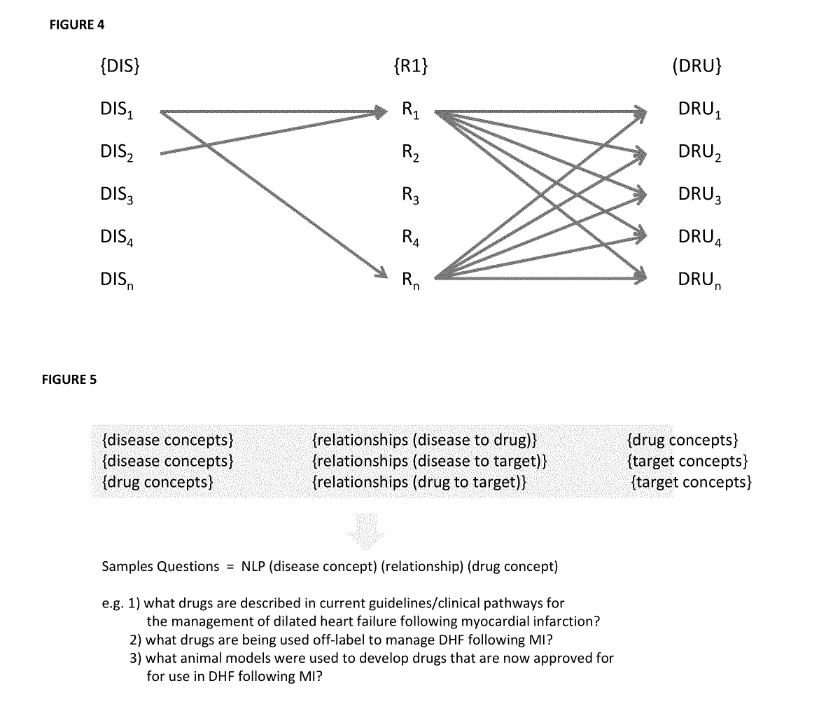

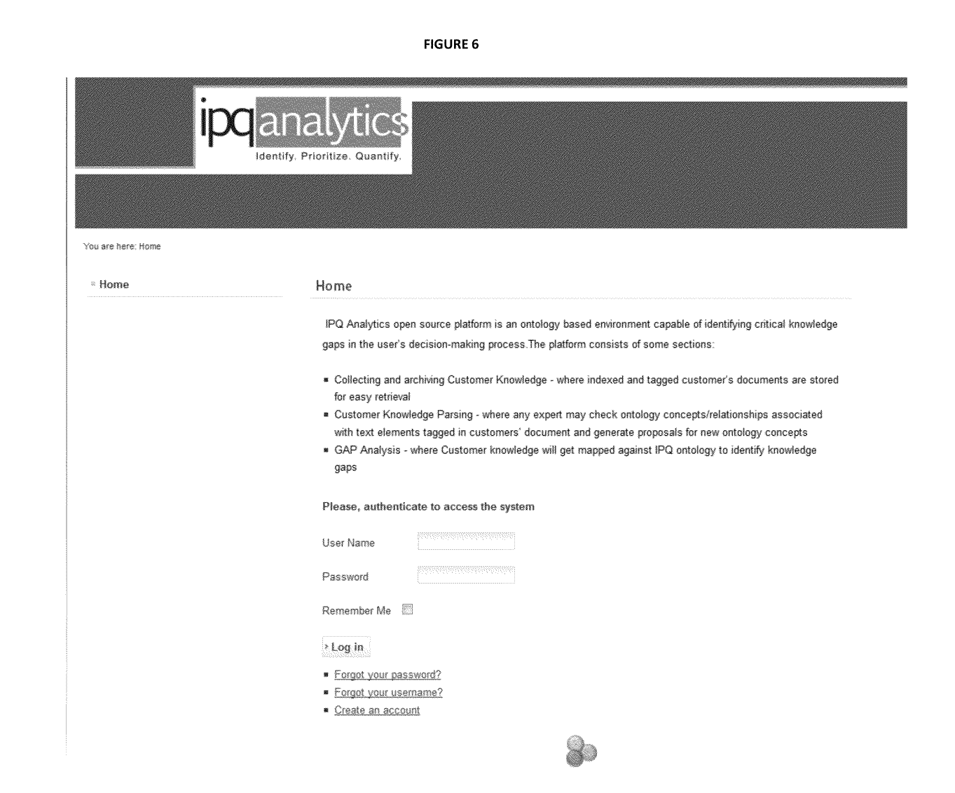

As contemplated herein, natural language questions may provide an interface into using the system. The questions may result from combinations of concepts and relationships within the system and as customized for a particular user. For example, FIG. 4 illustrates how such questions may result from various possible combinations of disease and drug concepts and their inter-relationships. As depicted in FIG. 5, a more general example of composing a questions set from the system is provided. By non-limiting example, natural language questions pertaining to {DIS} {R1} {DRU} may be: 1) What drugs are described in current guidelines/clinical pathways for the management of dilated heart failure following myocardial infarction?; 2) What drugs are being used off-label to manage DHF following MI?; and 3) What animal models were used to develop drugs that are now approved for use in DHF following MI?

To generate these natural language questions, the system utilizes an Expert or a team of Experts to collect, organize and parse client knowledge for concepts and relationships, which the system then compares against the system knowledge, to identify any client knowledge gaps. The natural language questions are then based at least in part on the identified gaps.

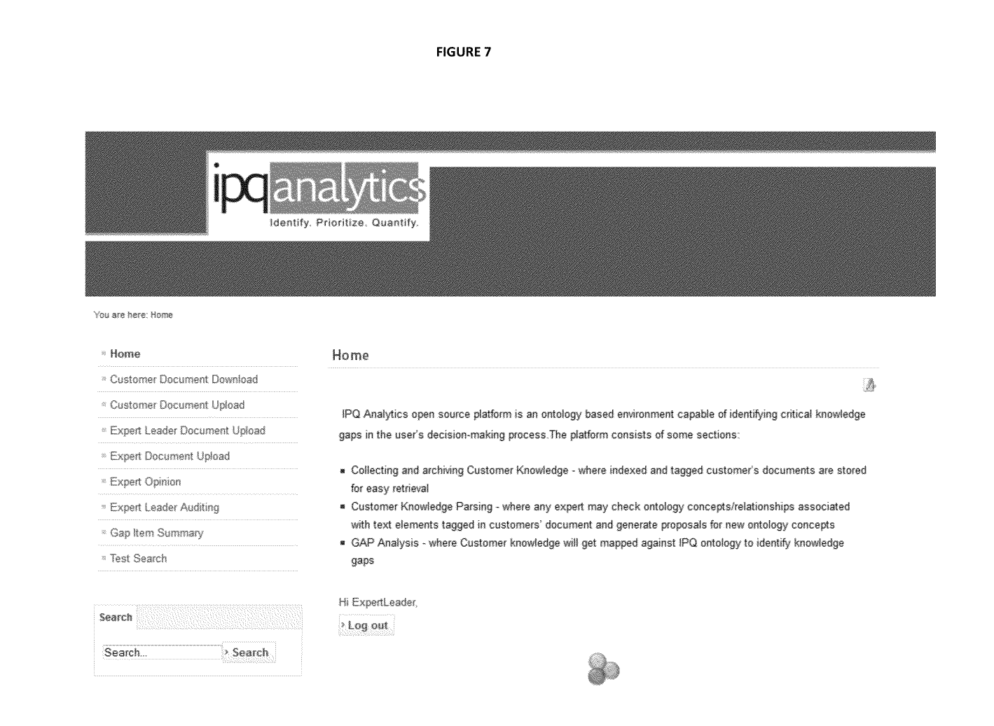

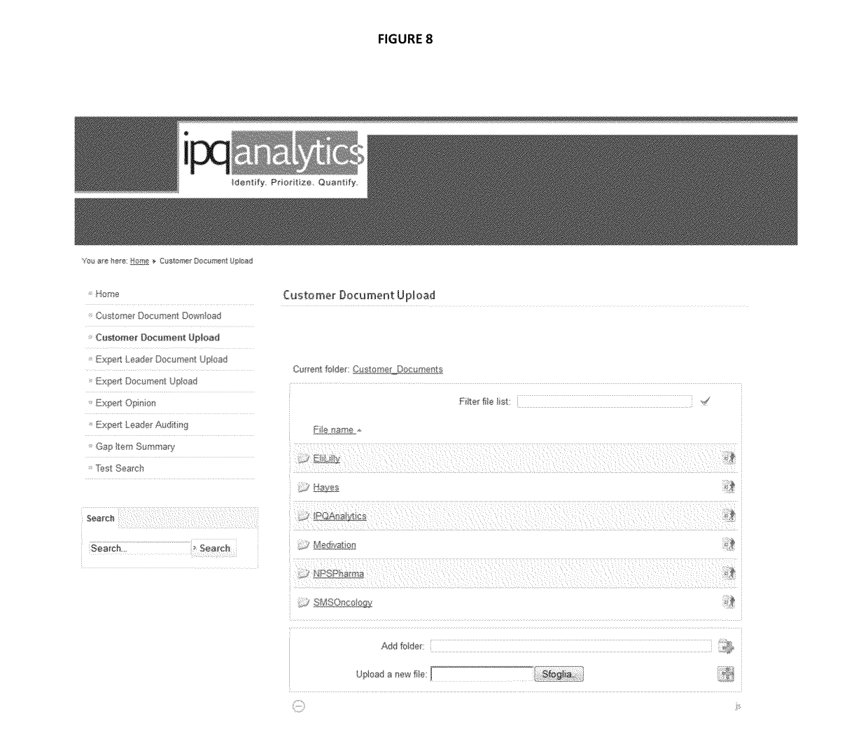

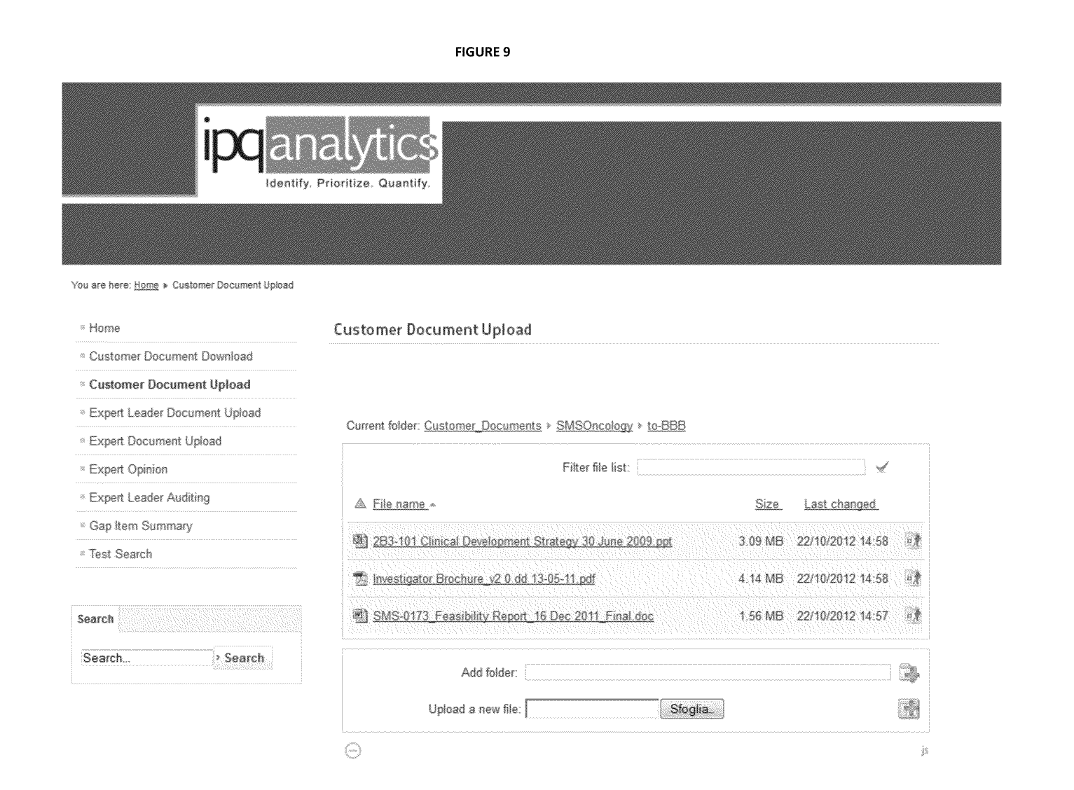

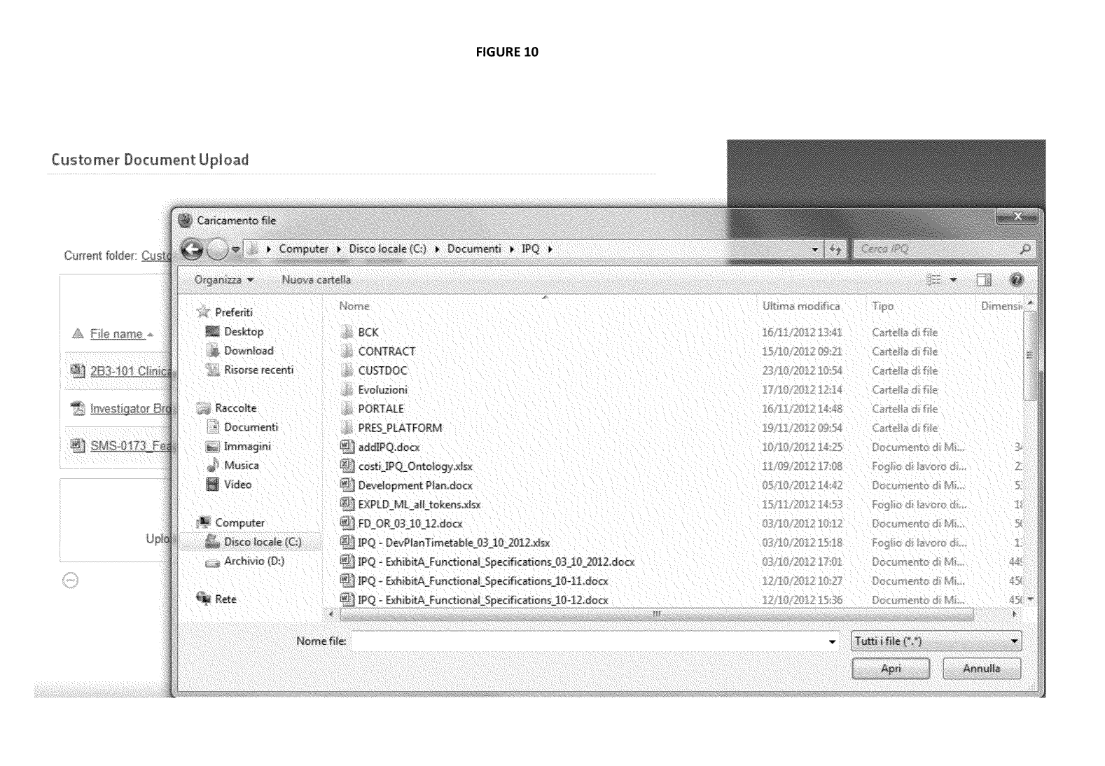

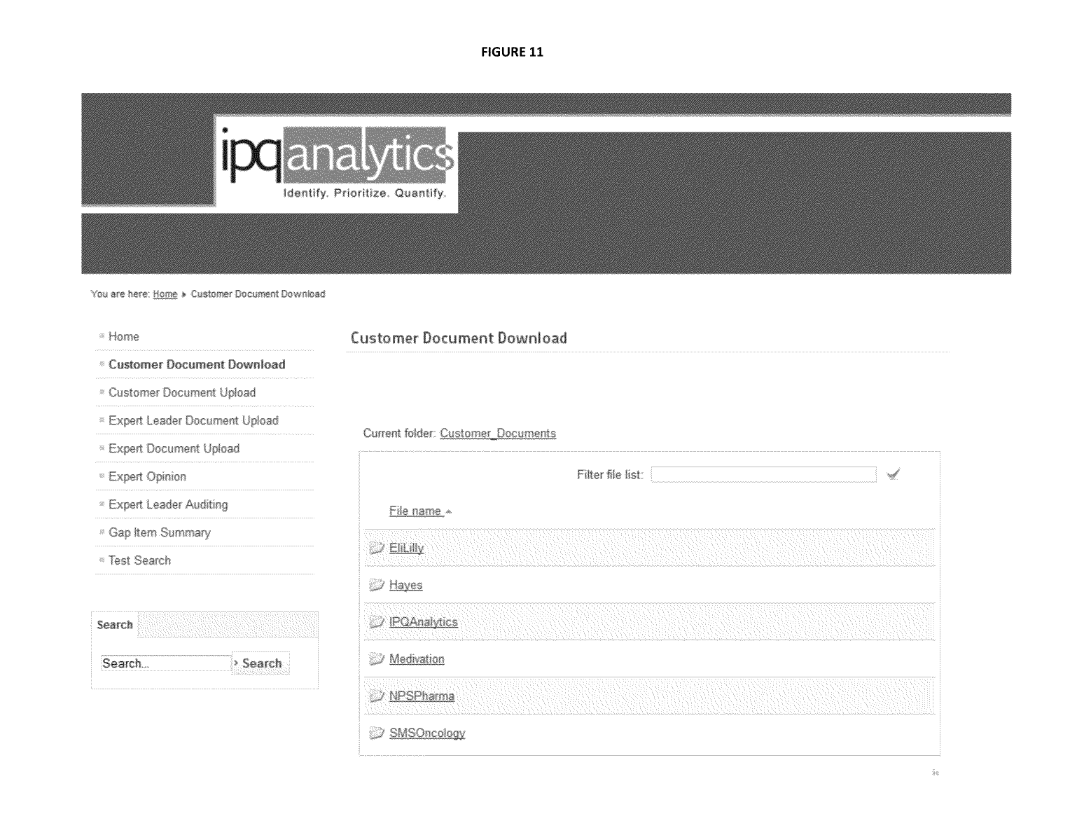

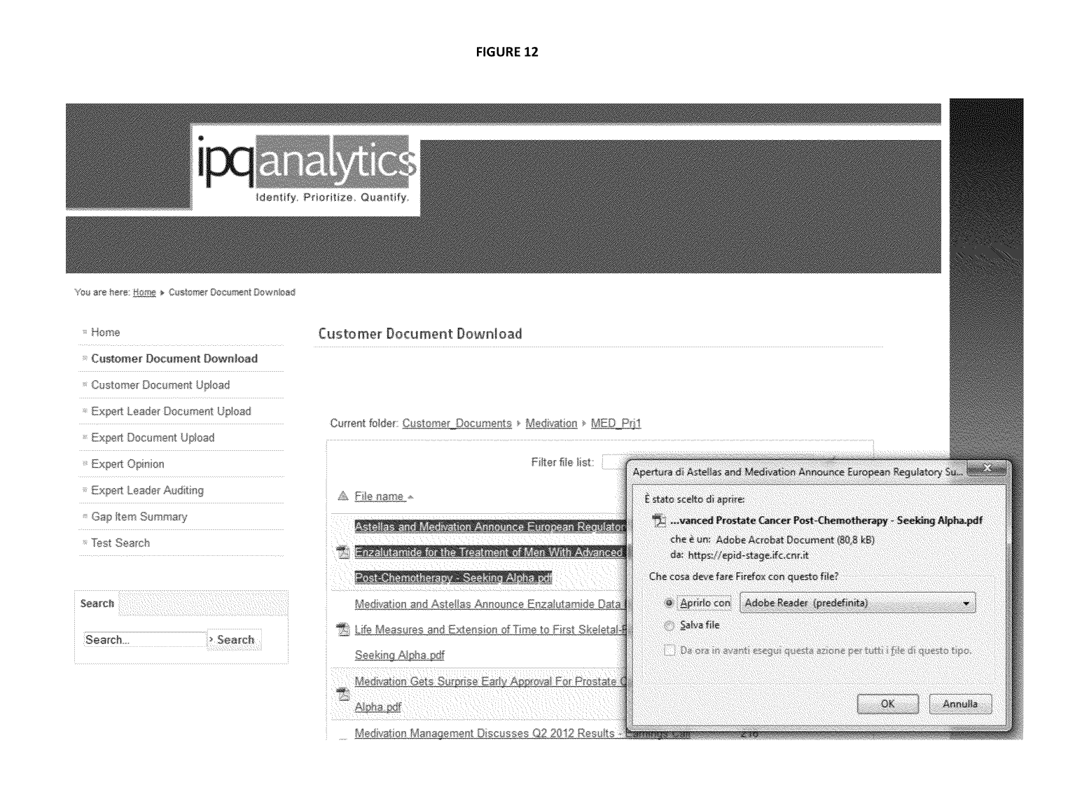

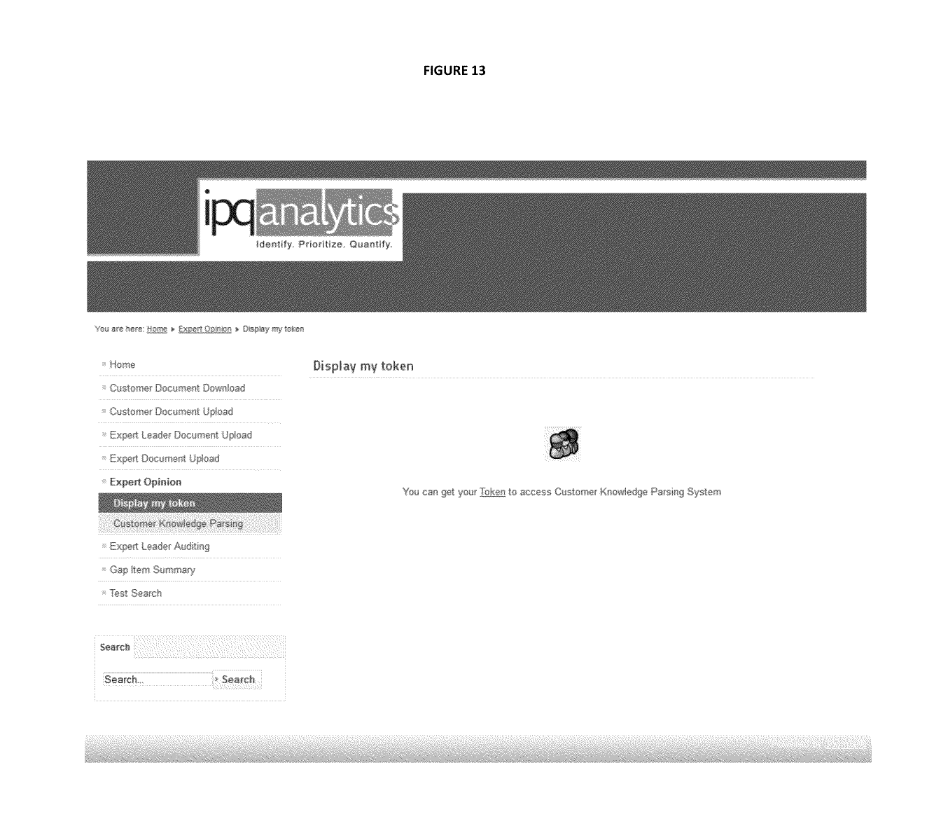

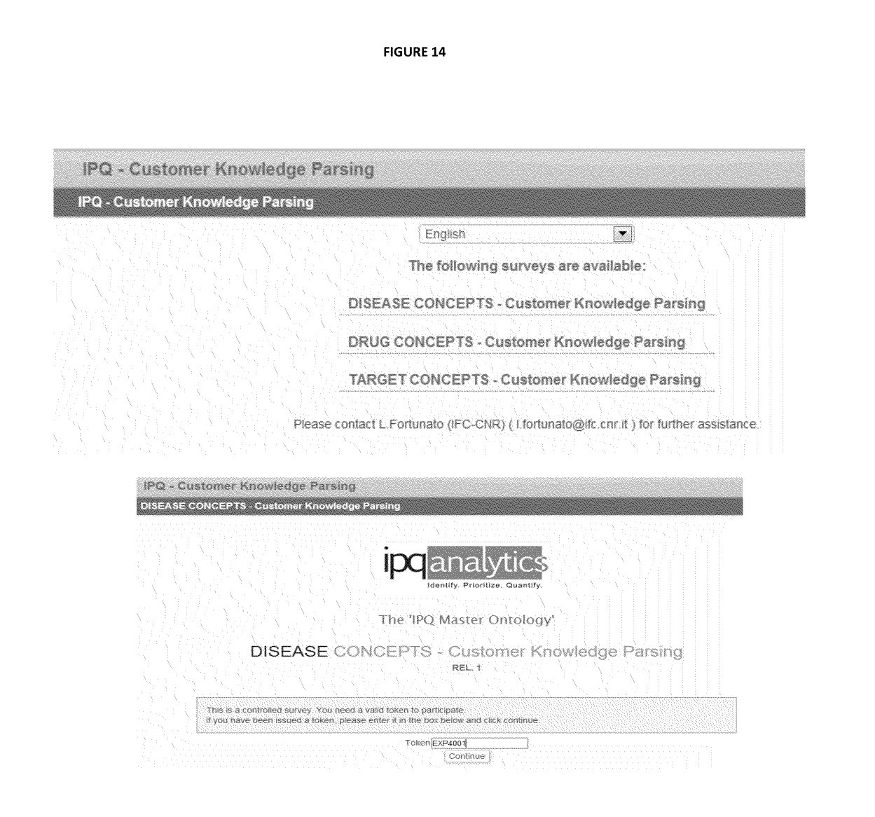

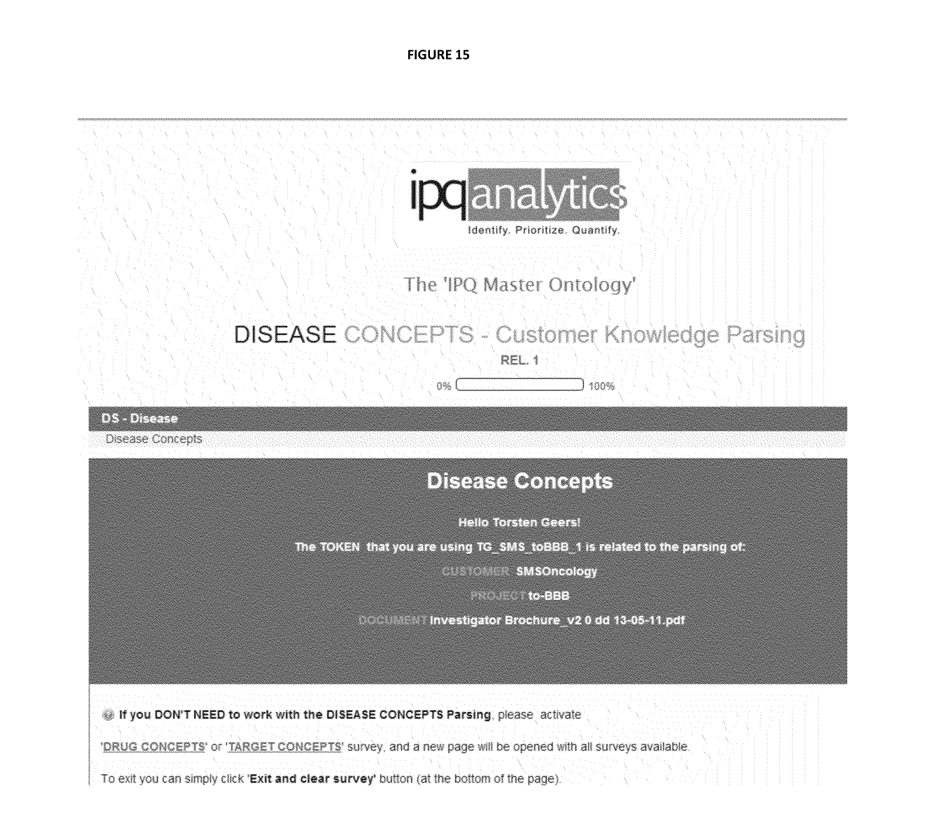

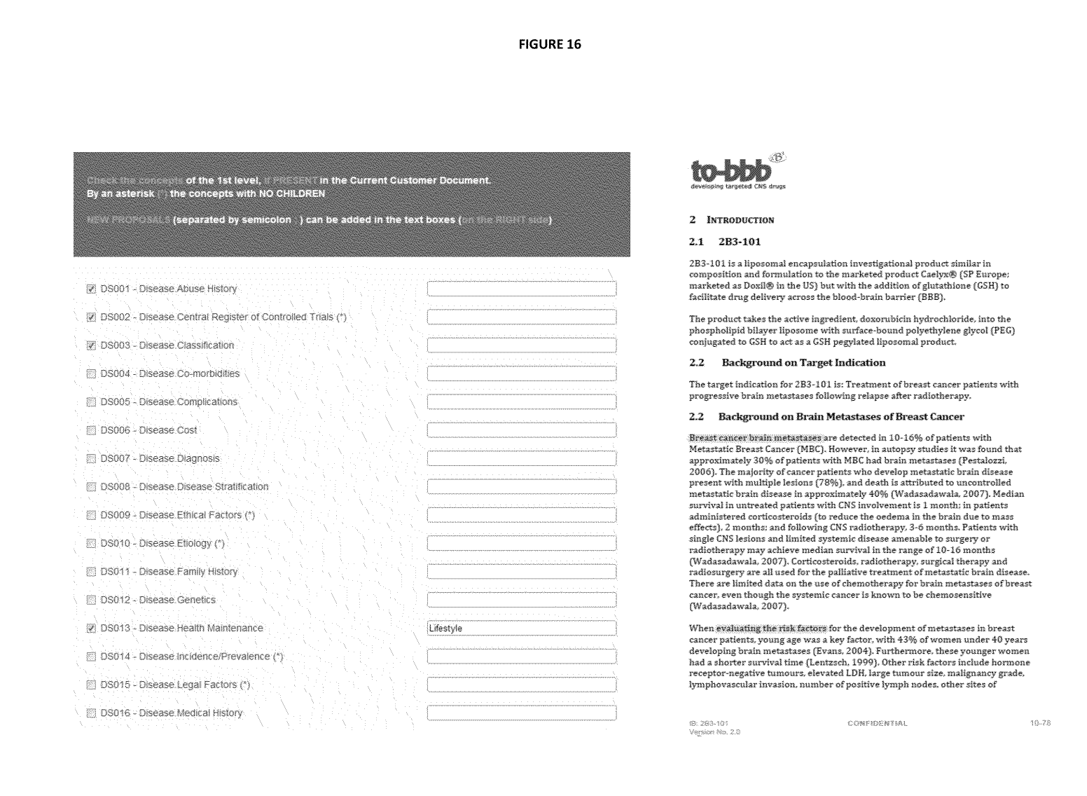

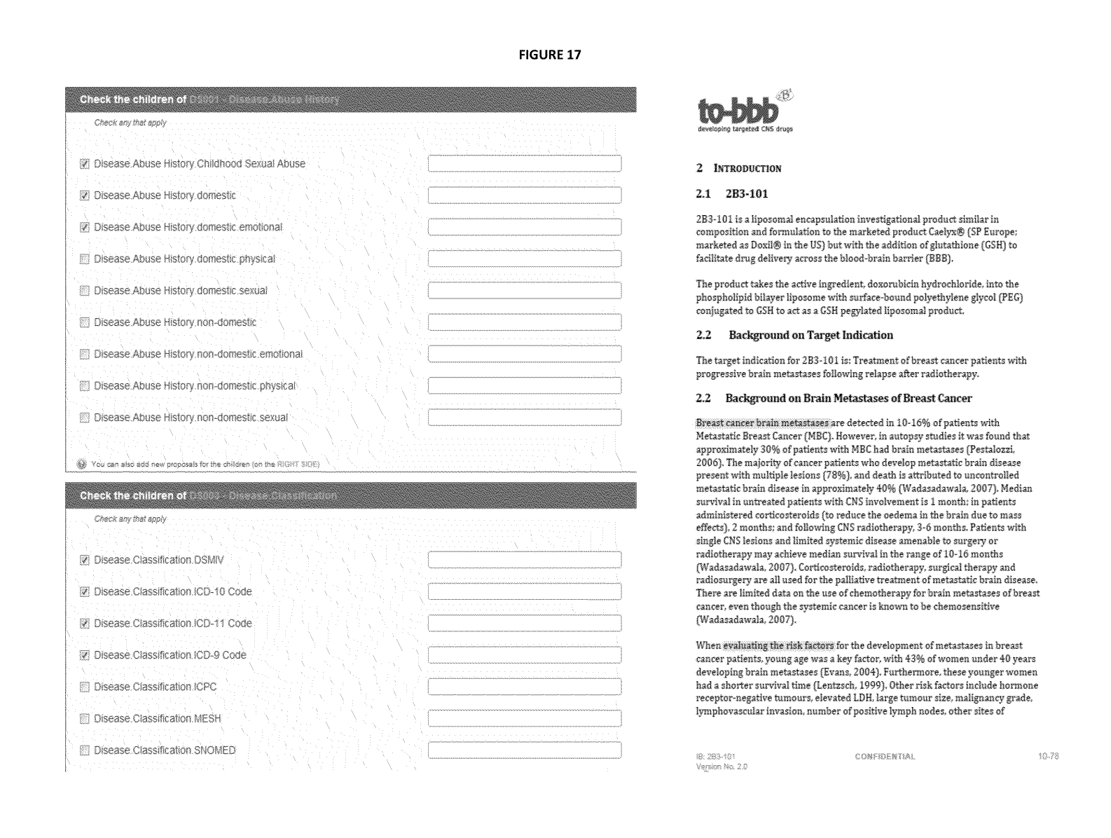

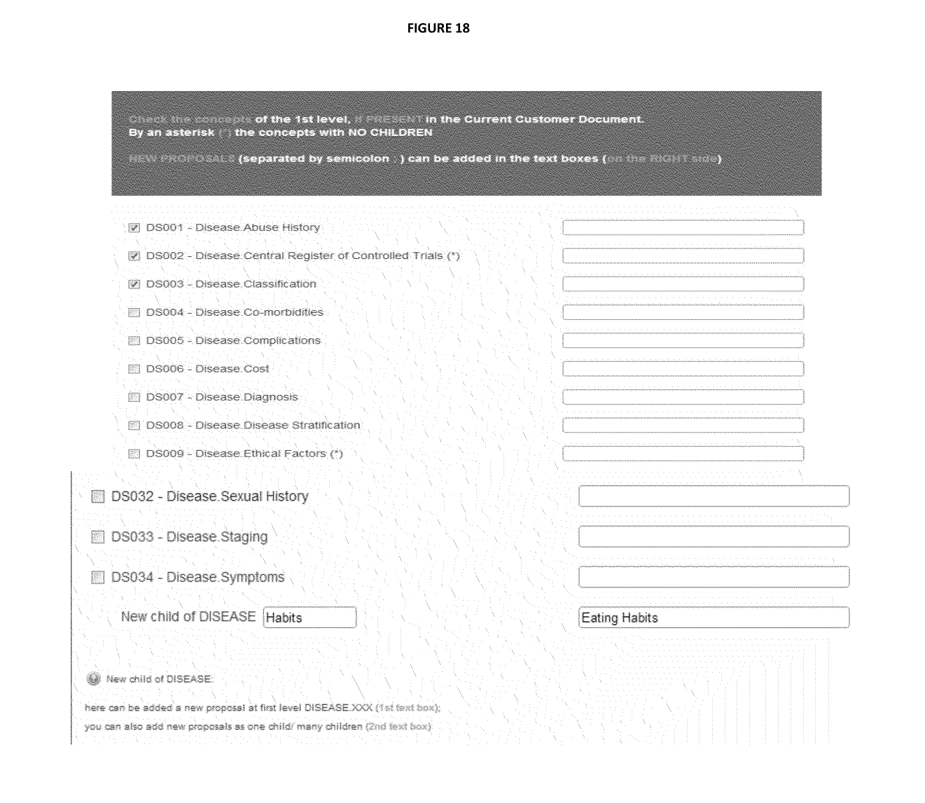

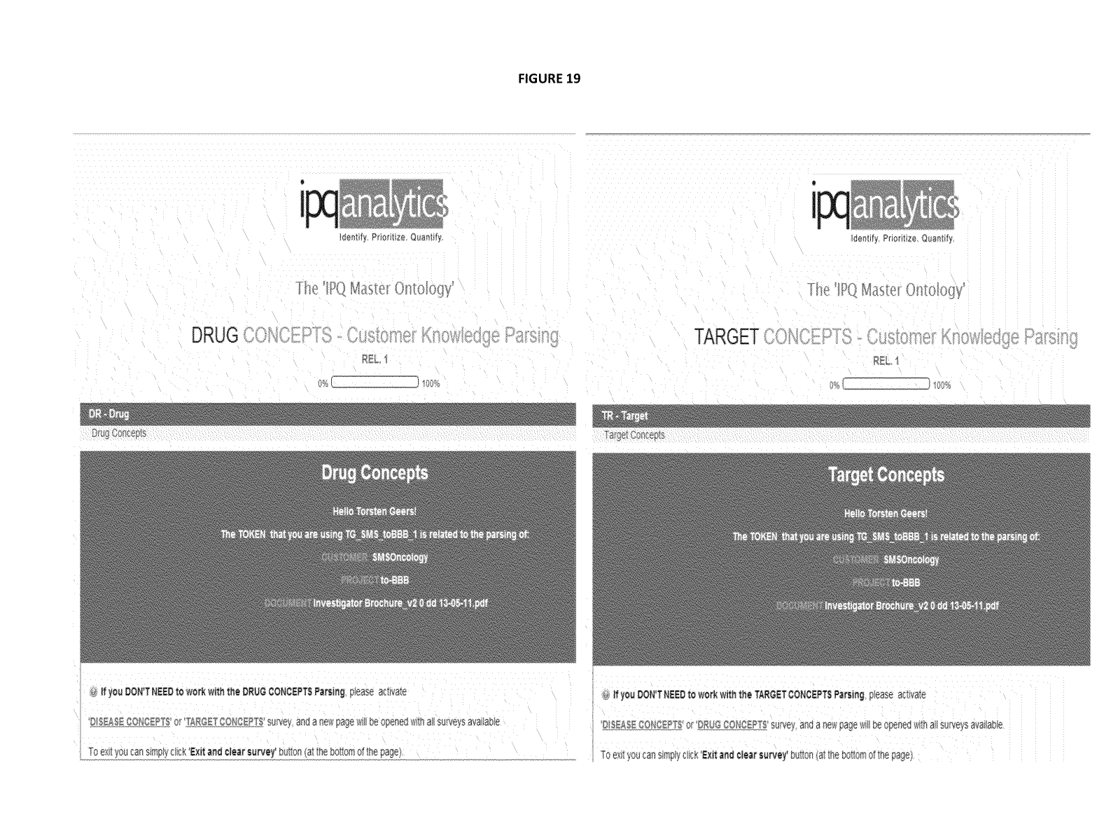

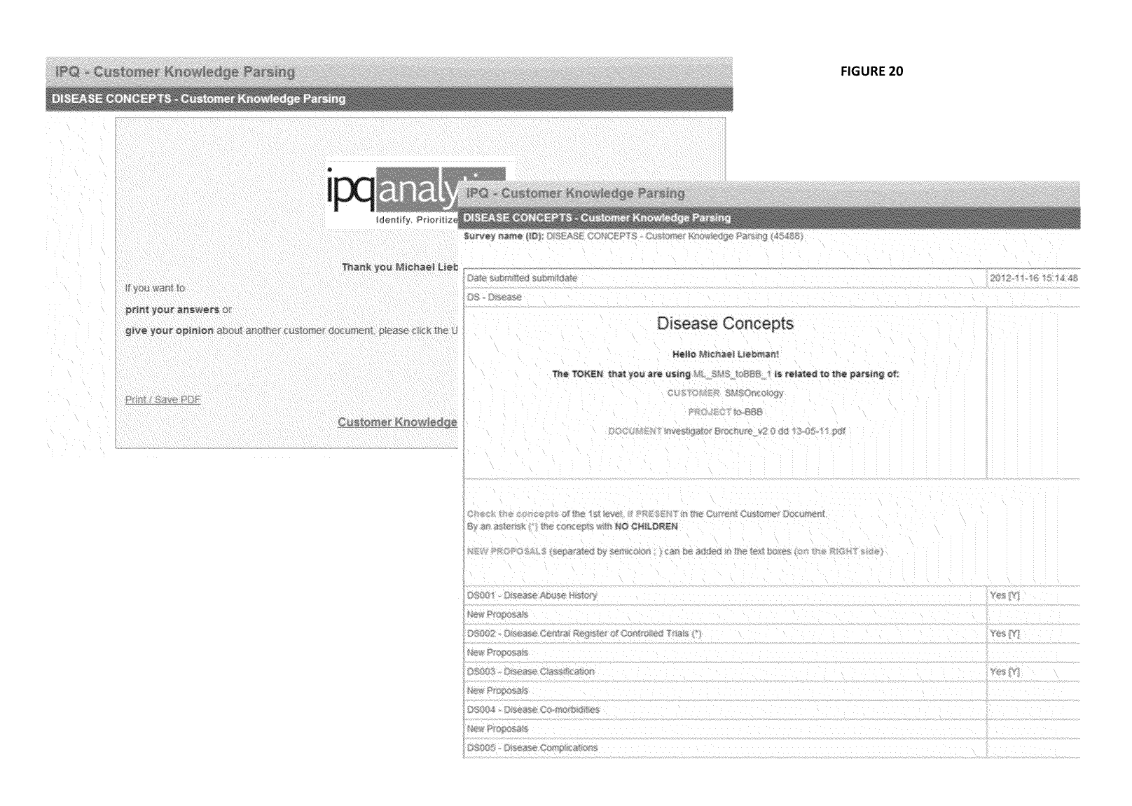

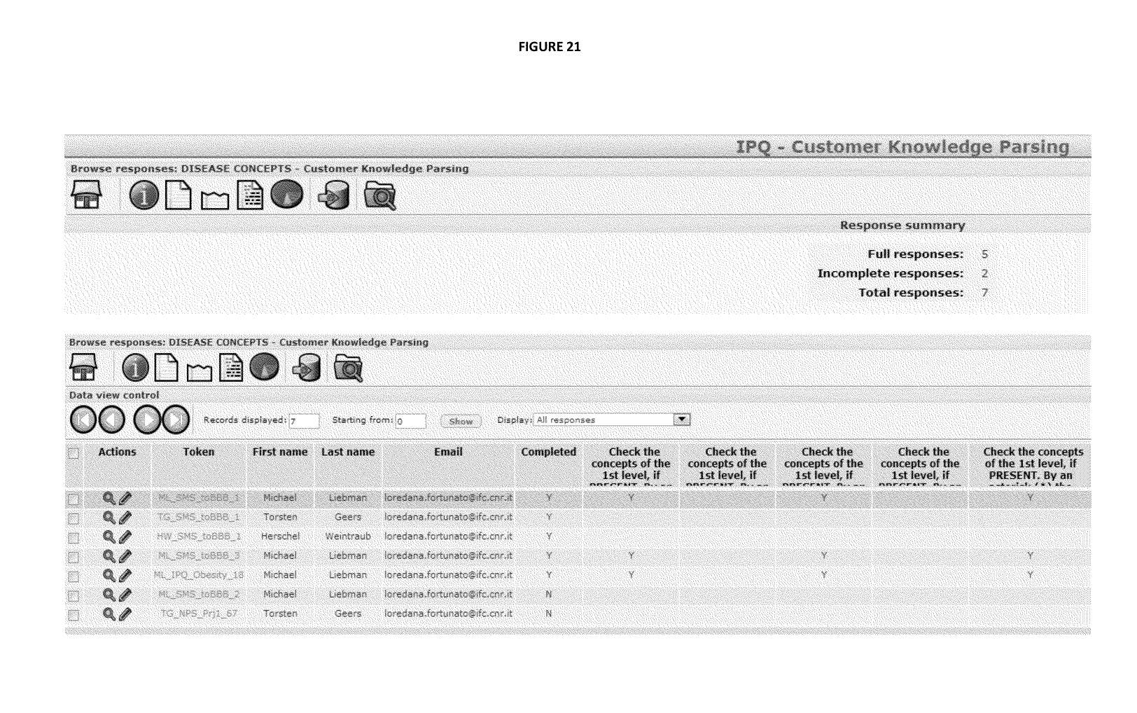

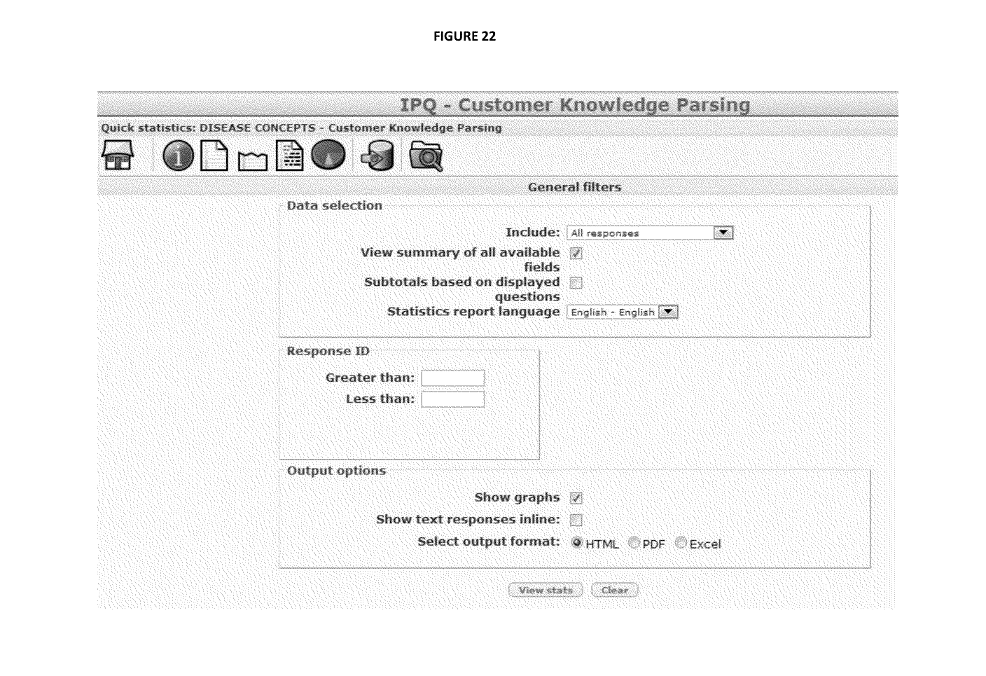

For example, in one embodiment and with general reference to exemplary system screenshots depicted in FIGS. 6-22, a team of domain Experts and an Expert Leader are provided with system login information to register and access the system of the present invention. Next, the client knowledge is uploaded into the system document library, for example in the form of digital documents such as word, pdf, excel, peg, png or any other digital format. Each uploaded document being given a unique identifier and organized according to Client, Project, Topic, or any other desired categories. Subject to the initial review of the Chief Editor, the client documentation is then assigned to a team of Expert Editors with specific domain background, typically at the MD or PhD level, to perform the initial knowledge parsing. This activity will evolve to include an initial assessment using natural language processing, within the system platform, to support preliminary analysis and enable the editorial staff to focus on the non-trivial instances. Next, each Expert Editor retrieves his/her assigned client documentation, extracts the concepts and relationships from said documentation and submits it into the system. The system then performs a gap analysis by comparing the concepts and relationships extracted from the client knowledge with the system ontology. During this process, the Expert may identify client document elements matching with existing concepts in the existing system ontology, and may further identify new concepts from the client document elements and propose those as new information items for the system ontology. The latter allows the system ontology to continuously evolve its knowledge base through use in client projects. In addition, the system also evolves through internally initiated projects that apply the same processes as outlined for client interaction. The Expert Editors are guided through this process by the system software platform as a survey process. For example, the system parent concepts may be automatically displayed and arranged in separate pages for Disease, Treatment (Drug) and Target Concepts, respectively. In each section, each parent can be exploded to show all the children and the Experts can tick or select any or all concepts already present in the client documents. At the same time, the Experts can make proposals for new concepts to be entered in the system database(s). Upon completion, the survey may contain all founded, missing and proposed concepts and/or relationships and can be available for reading, printing and exporting to a deliverable format. For any surveyed document, the Chief Editor may audit the survey via a system auditing function to improve quality control of the client knowledge parsing process. Upon completion of the client knowledge parsing or survey, the output from such process provides a “gap analysis” and may be stored in the system database, such as in a table having one column for every survey variable. Such variables may be, without limitation, Date of completion; Client; Project; Current document (CD); List of concepts and/or relationships found in CD already present in the system database; List of concepts and/or relationships not found in CD already present in the system database (missing concepts and/or relationships); or List of proposals for expanding the system. Any sort of report may be generated based on the table, and such reports may be run at any level, including the document level, project level or client level. Based on these reports, the Chief Editor can determine which proposals are accepted in order to extend the system concepts and relationships. From this, a final client report may be generated and delivered to the client, which may contain, without limitation, lists of source documentation provided by the client and a summary of one or more identified knowledge gaps in form of natural language questions.

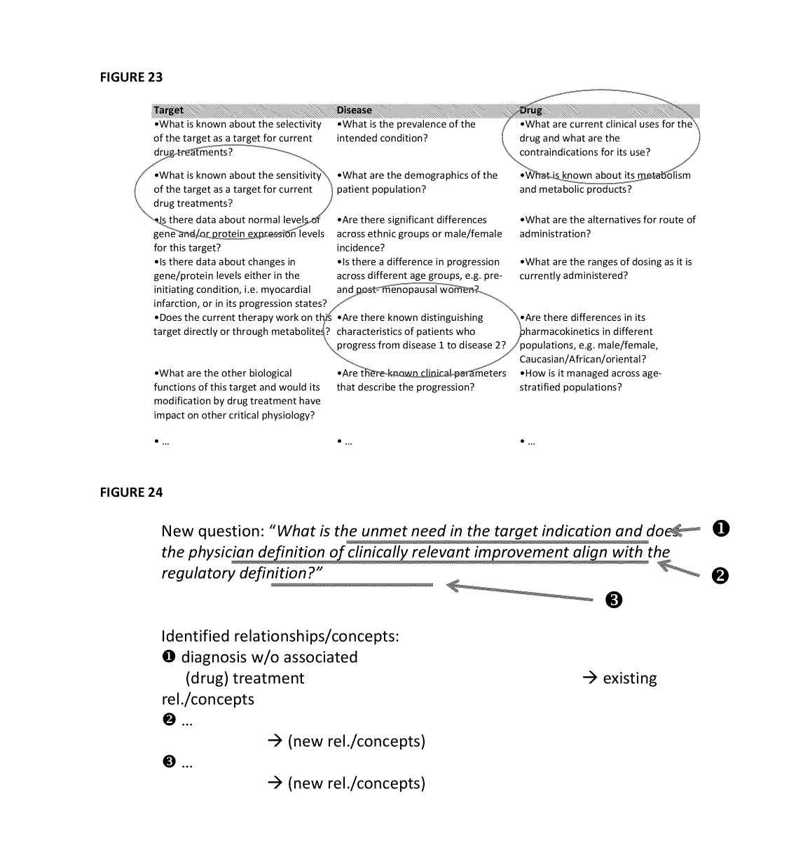

The natural language questions can be prioritized by the system and/or by the user based on relevance to a particular project. For example, as depicted in FIG. 23, a natural language question from each of the concepts “target,” “disease” and “treatment (drug)” has been selected and/or prioritized from a provided question set for each concept. This prioritization or selection may be made by a rules based algorithm, weighting mechanism, or simply by personal, user choice. Additionally, user generated natural language questions can also be parsed against existing concepts and relationships in the system. Furthermore, if desired concepts or relationships do not currently exist in the system ontology, such questions can lead to the expansion of these concepts and relationships within the system ontology, as shown in FIG. 24. For example, in the generation of the new question “What is the unmet need in the target indication and does the physician definition of clinically relevant improvement align with the regulatory definition?,” question component (1) (unmet need in the target indication) pertains to the existing concept of diagnosis without associated drug treatment, while question components (2) (physician definition) and (3)(regulatory definition) pertain to new relationships and/or concepts.

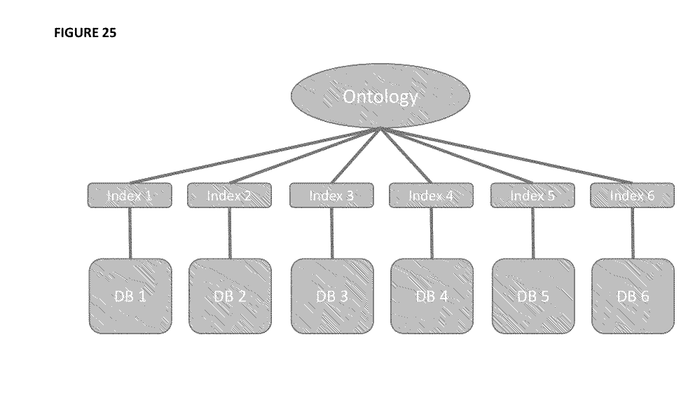

As illustrated in FIG. 25, relevant knowledge repositories, such as public and commercial databases as well as client proprietary data spanning the clinical, molecular and commercial domains, will be mapped against the system ontology on the data field/index level. It should be appreciated that the system of the present invention is not limited in the number, type or location of the database(s) or other knowledge repository. However, in some embodiments, a user may have access to all information sources, or it may be limited, such as via a subscription level limiting the amount or type of information available to the user.

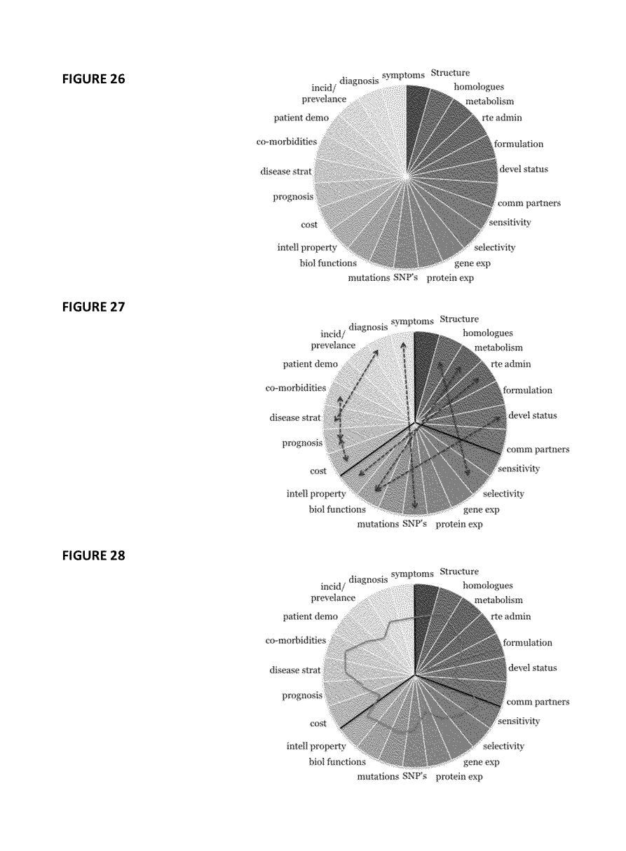

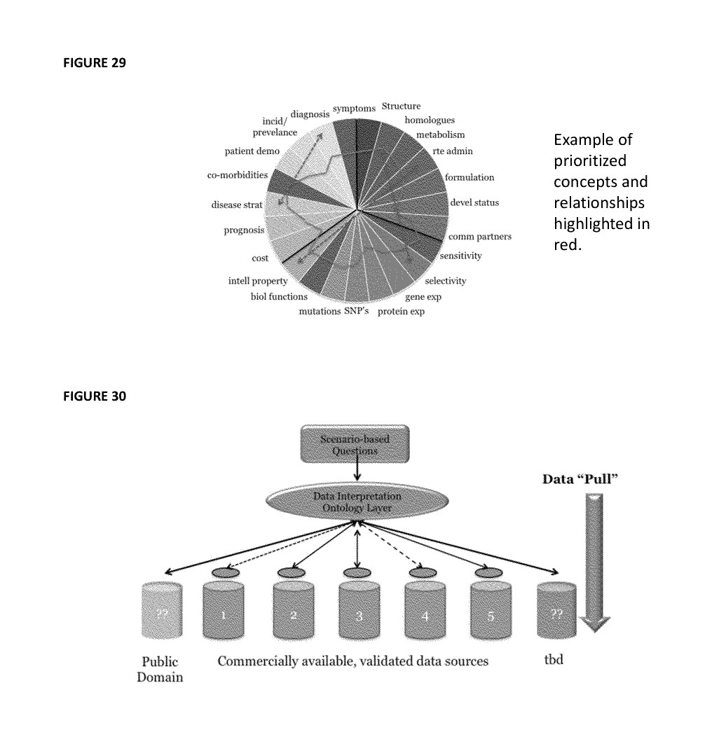

The interpretation of the client knowledge by the system produces an enhanced view of additional knowledge dimensions/concepts and relationships. As depicted in FIGS. 26 and 27, the system provides a unique approach to enhancing the correlation of information along virtually any dimension between the various concepts and relationships designated by the system. Furthermore, a measure of the available knowledge within each of these dimensions can be visualized using the linkage between the system and the databases, as demonstrated in FIG. 28. As depicted in FIG. 29, the system or user may additionally prioritize the dimensionality of the problems using the extended knowledge and based on commercial priorities and other considerations.

After question selection and prioritization, relevant data (meaning only data that specifically responds to the prioritized dimensions) from the data pool encompassed by the available databases and disparate repositories will be retrieved and aggregated, as illustrated in FIG. 30. In one aspect, the system quantifies both the amount of data (or knowledge) available and/or missing. Quantifiable risk assessment enables further prioritization and conversion of potential risk into a directed action plan. In this regard, the system of the present invention may also include a scoring metric, or algorithm, by which to weight each information item result category pulled by the system, and to calculate a value that is determinative of the assessed risk. It should be appreciated that the values designated for each information item category may vary according to the targeted knowledge pulled. Further, the number or combination of information item categories will also effect the values designated. Further, the final score provided by the system may include threshold values, where a score of equal to or above a designated value indicates levels of risk. Alternatively, final score ranges can be used to designate categories. It should be appreciated that the system of the present invention is not limited to any predetermined value, number or other nomenclature.

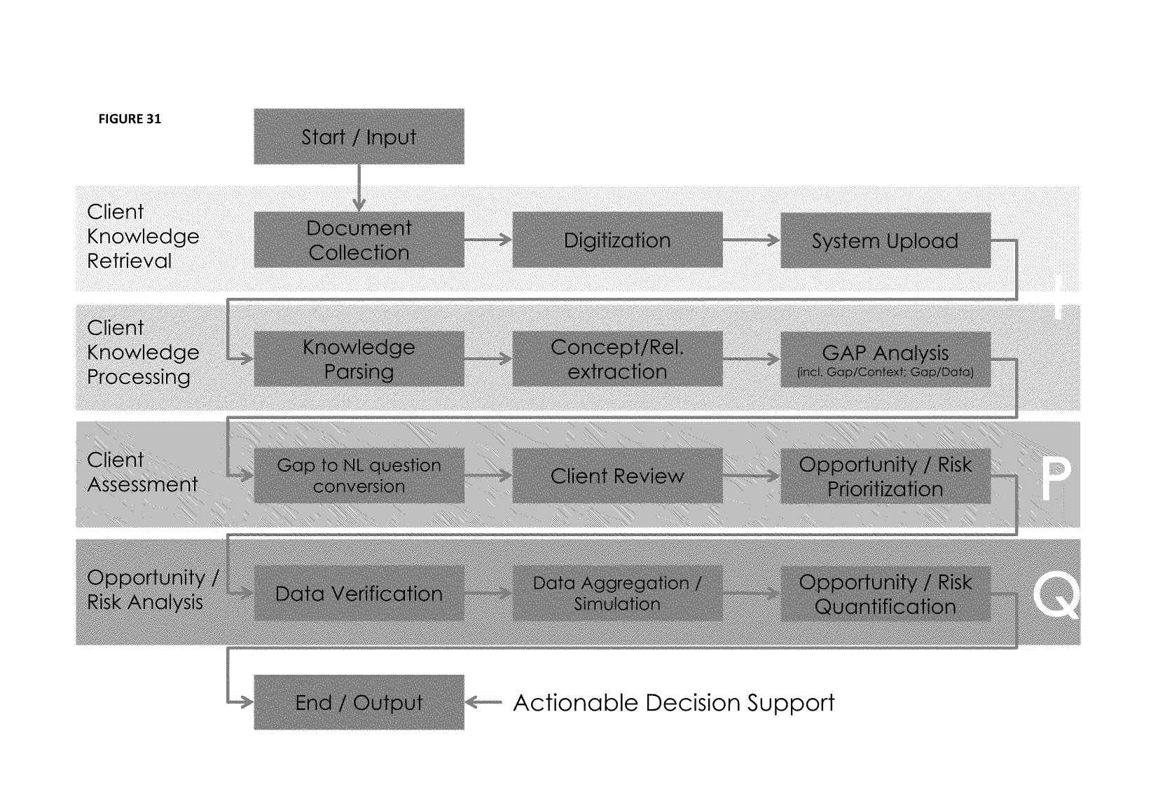

FIG. 31 is a flowchart depicting the various steps and/or stages performed by the system of the present invention. In the following exemplary process, the system includes both automated and manual steps. It should be appreciated that, depending on the application, the present invention may be executed as an entirely automated system, or a partially automated system. Referring now to FIG. 31, the process generally includes three phases, identified as the I-phase, P-phase and Q-phase. The I-phase starts with the initial upload, digitization and management of client documentation representing the client's project knowledge. The platform then supports editors in identifying concepts and relationship within the client's documentation (“document parsing”). The system platform then develops a gap analysis by comparing client knowledge to system's knowledgebase (or ontology) that in this exemplary embodiment spans critical perspectives in life sciences and healthcare. Identified gaps are validated for their relevance in context of the project and subsequently converted into a natural language questions for convenient client communication and prioritization. As the final step in the I-Phase, a report summarizing findings is generated and made available to the client. The completed I-Phase is followed by the P-Phase, in which clients can review and prioritize the findings according to their corporate objectives. In the Q-Phase, the platform supports the identification and linkage of relevant internal or external datasets to the prioritized questions for purposes of opportunity/risk quantification.

By further example of the I-Phase, the document collection step may include collection of primary documents, provided by the client, and may include such documents as the investigator portfolio, feasibility study analysis, CRO proposals and any associated materials considered critical by the client. In the digitization step, all materials may be digitized for storage and manipulation within the system platform to facilitate analysis. In the system upload step, all digitized materials are securely uploaded into the system document repository and uniquely cataloged by client and project to enable retrieval and referencing to specific documents during the analysis process. In the knowledge parsing step, the system may utilize a team of expert editors with specific domain background, typically at the MD or PhD level, to perform the initial knowledge parsing. This activity will evolve to include an initial assessment using natural language processing, within the system platform, to support preliminary analysis and enable the editorial staff to focus on the non-trivial instances. In the concept/relationship extraction step, analysis and parsing is accomplished through comparison of the concepts and relationships extracted from the client documents and the system ontology developed to represent the system knowledgebase and containing concepts and relationships. In the gap analysis step, identification of those concepts and relationships that are not present in the client's documents but that exist within the system ontology will lead to evaluation as to their potential to be either risk factors or opportunities and exposed to the client as natural language queries.

By further example of the P-Phase, the system allows clients to review and prioritize the I-Phase findings according to their corporate objectives. In this phase, identified gaps are validated for their relevance in context of the project and subsequently converted into natural language queries for convenient customer communication and prioritization. In the gap to natural language question generation step, following completion of the I-Phase and identification of concepts and relationships that are not present in the client documentation, natural language questions are generated for use by the multi-disciplinary client teams to evaluate and prioritize the most relevant issues for further evaluation. An example of this is the concepts for disease stratification, e.g. hyperlipidemia with concomitant diabetes, for drug, e.g. aspirin, and for relationships, e.g. off-label use. The question that would be generated would be: Is aspirin being used, off-label, to treat those patients with hyperlipidemia who also have diabetes? Or the variant, Has aspirin been considered for off label use in patients who have hyperlipidemia and also present with diabetes? These question may be generated by the system professional staff or by automated processing tools. In the client review step, client review of the natural language questions typically involves clinical, research, marketing groups as well as therapeutic area heads and results in a prioritization based on commercial priorities within the client's organization, e.g. decision to market solely in China. The system is available to participate and advise in these discussions as well as determine the amount and sources of relevant data in the particular context of the client. In the opportunity/risk prioritization step, the initial phase of opportunity/risk prioritization involves the identification and preliminary assessment of relevant data in terms of accessibility, i.e. what data sources may be available, how current is the data, is it validated? This is based on the system's relationship with data providers/vendors through strategic partner models and also provides the system's partners with an additional channel to establish their value proposition with existing or new clients.

By further example of the Q-Phase, the platform supports the identification and linkage of relevant internal or external datasets to the prioritized questions for purposes of opportunity/risk quantification. In the data verification step, the first stage of data verification involves checking data values against expected data ranges to identify outliers as well as to evaluate potential conflicts where potentially equivalent data from different sources may differ significantly. Verification also deals with the variation in measurement methodologies that may exist, e.g. determination of her2/neu status in breast cancer patients by IHC (immune-histochemistry) vs FISH (fluorescent in situ hybridization) and annotates these differences for further validation or clarification. In the data aggregation/simulation step, data aggregation involves bringing the relevant data, e.g. contextual data, into the analysis system for further processing, e.g. population statistics concerning coronary artery disease patients, and determination if there is missing data (elements or fields) or if the existing data fully spans the range of interest for analysis. Data simulation procedures are available to approximate missing data based on distribution and range analysis and have been verified in independent analyses. In the opportunity/risk quantification step, quantitative evaluation of potential opportunity or risk is based on an integrated approach that includes statistical and Bayesian analysis as well as non-parametric evaluation. This analysis is performed in parallel and the resulting outcomes are compared for consistency and evaluated further in terms of potential variation, i.e. ability to establish the variance in the result such that a bounded range can be established. In this manner, the quantification is able to deal with both high and low resolution data and determine its significance based on data available from validated (or non-validated, public domain) data sources as well through simulation as noted above. Accordingly, the system and method of the present invention is able to identify and quantify the amount of data (internal, commercial or public) that directly corresponds to the relevant concepts and relationships because it maintains an ongoing mapping of its components to the data fields of the data resources from its strategic partners, e.g. Thomson Reuters, Elsevier. Access to the actual data is not required at this point of the analysis.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A method of assessing risk and opportunities associated with decision support for a project, comprising:
uploading a plurality of client knowledge documents to a computer memory accessible by a software application;
extracting at least one concept or relationship in at least one domain from the plurality of client knowledge documents;
comparing the at least one concept or relationship to an existing knowledgebase of concepts and relationships in the at least one domain;
identifying at least one gap between the at least one extracted concept or relationship and the concepts and relationships of the existing knowledgebase;
generating at least one question pertaining to the identified gap; and
quantifying at least one risk or opportunity of the project based on the at least one question generated.

2. The method of claim 1, wherein the generated questions are natural language questions.

3. The method of claim 2, where the questions are based on the relationship between two or more concepts.

4. The method of claim 1, wherein the concepts are selected from the group consisting of treatment (drug), target and disease.

5. The method of claim 1, further comprising prioritizing at least one concept or relationship based on the generated questions.

6. The method of claim 1, wherein the plurality of client knowledge documents are parsed by at least one expert.

7. The method of claim 1, further comprising generating new concepts or relationships for the existing knowledgebase based upon the uploaded client knowledge documents.

8. The method of claim 1, further comprising converting the quantified risk or opportunity into an action plan.

9. A system for assessing risk and opportunities associated with decision support for a project, comprising:
a computer interface for uploading a plurality of client knowledge documents;
a computer executable analytics engine communicatively connected to the computer interface for comparing at least one concept or relationship in at least one domain found in the client knowledge documents to an existing knowledgebase of concepts and relationships in the at least one domain;
wherein the analytics engine identifies at least one gap between the at least one concept or relationship found in the client knowledge documents and the concepts and relationships of the existing system knowledgebase;
a question generator that generates at least one question pertaining to the identified gap; and
a quantifier that quantifies at least one risk or opportunity of the project based on the at least one generated question.

10. The system of claim 9, wherein at least one identified concept or relationship based on the generated question is prioritized.

11. The system of claim 9, wherein the generated questions are natural language questions.

12. The system of claim 11, wherein the question generator is a person.

13. The system of claim 11, wherein the question generator is a computer software application.

14. The system of claim 11, wherein the question generator comprises a computer software application and a person.

15. The system of claim 9, where the questions are based on the relationship between two or more concepts.

16. The system of claim 15, wherein the concepts are selected from the group consisting of treatment (drug), target and disease.

17. The system of claim 9, wherein the analytics engine generates new concepts or concept relationships for the existing knowledgebase based upon the uploaded client knowledge documents.

18. The system of claim 9, wherein the analytics engine generates new concepts or concept relationships for the existing knowledgebase based upon the non-client based knowledge documents.
